(19) United States
(12) Patent Application Publication
(10) Pub. No.: US 2025/0106738 A1
(43) Pub. Date: Mar. 27, 2025

(54) MOBILE NETWORK BLACKLIST FOR SATELLITE NETWORKS

(71) Applicant: T-Mobile USA, Inc., Bellevue, WA (US)

(72) Inventors: Kyeong Hun An, Sammamish, WA (US); Ran Chen, Overland Park, KS (US); Mathew George, Kirkland, WA (US); Kulandaivel Marappa Gounder, Bothell, WA (US); Nilesh Ranjan, Sammamish, WA (US)

(21) Appl. No.: 18/472,205

(22) Filed: Sep. 21, 2023

(51) Int. Cl. H04W 48/14; H04W 84/04

(52) U.S. Cl. CPC H04W 48/14; H04W 84/042

(57) ABSTRACT

The present technology relates to a mobile network blacklist for satellite networks. Information indicative of a satellite network can be stored within a mobile network blacklist to prevent the transmission of a wireless access request to the satellite network. When it is determined that no approved network is available to provide a wireless communication service, the information indicative of the satellite network can be removed from the mobile network blacklist to enable the transmission of a wireless access request for the satellite network to provide the wireless communication service. In doing so, the satellite network can provide the wireless communication service when other approved networks are not available to provide the wireless communication service.

### BACKGROUND

Current wireless communications systems (e.g., fifth-generation (5G) mobile networks) utilize base stations to communicate with a user equipment (UE). Base stations can be located at the surface of the Earth and support telecommunications coverage in a surrounding area. When in a coverage region of the base station, the UE can connect with the base station to communicate data through the network. Currently, the sixth-generation mobile system standard (6G) is under development. In contrast to 5G, 6G enables the UE to communicate directly with an orbiting satellite. The UE can connect to the satellite when within a coverage region of the satellite. In general, a satellite can provide a larger coverage region and can more easily provide coverage to remote locations. Accordingly, network providers are utilizing non-terrestrial networks (NTNs) to increase coverage and provide improved networks.

### BRIEF DESCRIPTION OF THE DRAWINGS

Detailed descriptions of implementations of the present invention will be described and explained through the use of the accompanying drawings.

FIG. 1 illustrates a wireless communications network that can implement aspects of the present technology.

FIG. 2 illustrates 5G core network functions (NFs) that can implement aspects of the present technology.

FIG. 3 illustrates a method for managing a mobile network blacklist for satellite networks in accordance with aspects of the present technology.

FIG. 4 illustrates components of a computing device that can implement aspects of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

New generations of wireless communication, such as 6G, utilize satellites to improve network coverage. Given that satellites are not bound to the surface of the Earth, satellites can provide a larger coverage region than base stations and more easily provide coverage in remote locations. As a consequence of this increased coverage region, a greater number of users may compete for communication resources provided by the satellite networks, thereby increasing congestion. This congestion can be worsened by the limited wireless resources that are provided by these networks. For example, satellite networks can be difficult or costly to implement, resulting in these networks having decreased bandwidths or greater latency. Thus, satellite networks can be resource-constrained due to increased competition for limited communication resources.

Given that satellite networks can be more resource-constrained than terrestrial networks implemented through surface-bound base stations, mobile network operators can choose to limit network traffic on satellite networks to ensure that sufficient wireless resources are available to service users in coverage regions that are only covered by the satellite networks. For example, satellite networks can expand the coverage region of mobile networks into remote areas in which it can be too challenging or cost prohibitive to install base stations. Thus, users located in these regions can only receive wireless communication services through the satellite networks. To prioritize satellite network resources for these users, when both a terrestrial network and a satellite network are available to provide a wireless communication service, a mobile network operator can choose to prevent requests for the wireless communication service to be provided through the satellite network.

The present technology relates to techniques, apparatuses, and systems for limiting requests to a satellite network for a wireless communication service when a terrestrial network is available to provide the wireless communication service. In aspects, information related to the satellite network (e.g., a Public Land Mobile Network (PLMN) code) can be stored in a mobile network blacklist of the wireless device, such as a Forbidden PLMN (FPLMN) list. When information related to a mobile network is stored in the mobile network blacklist, the wireless device can be prevented from initiating a request for the mobile network to provide the wireless communication service.

In general, the satellite network can be placed on the mobile network blacklist when a terrestrial network is available. When the wireless device determines that no terrestrial network is available to provide the wireless communication service, the satellite network can be removed from the mobile network blacklist to enable the wireless device to request for the wireless communication service to be provided by the satellite network. In response to the request, the wireless device can connect to the satellite network such that the satellite network provides the wireless communication service to the wireless device. The satellite network can provide the wireless communication service until it is determined that a terrestrial network can provide the wireless communication service, at which point the wireless device can connect to the terrestrial network such that the wireless communication service is provided to the wireless device through the terrestrial network. Once no longer needed for providing the wireless communication service, the satellite network can once again be indicated in the mobile network blacklist to prevent the wireless device from attempting to connect with the satellite network.

The available networks for providing the wireless communication service can be determined using information that is broadcast by the networks. In some cases, the networks can broadcast information related to the networks that can be received by the wireless device and used to determine to which network to connect. For example, networks can broadcast an associated PLMN code within system information blocks. The wireless device can receive the system information blocks and determine if the PLMN code of the network is associated with a network to which the wireless device is allowed to connect (e.g., a home network (a network having the same Mobile Country Code (MCC) and Mobile Network Code (MNC) as an International Mobile Subscriber Identity (IMSI) number of the wireless device) to which the wireless device is subscribed or a partnered network that is partnered with the home network to allow roaming on the partnered network). In this way, the available network can be determined without requiring additional information from the networks. As a result, the present technology can seamlessly be integrated into past, current, and future communication networks.

In some embodiments, the mobile network blacklist can be managed by an application installed onto a Subscriber Identity Module (SIM) card of the wireless device. The SIM card can be provided by a mobile network operator that provides a home network to which the wireless device is subscribed. The application installed onto the SIM card can periodically request the broadcast information received from the networks available to the wireless device. The application can analyze the broadcast information to determine if a terrestrial network is available to provide the wireless communication service. For example, the application can determine if the broadcast information is associated with a home terrestrial network or a partnered terrestrial network. If no terrestrial network is available to provide the wireless communication service, the satellite network can be removed from the mobile network blacklist. If a terrestrial network is available to provide the wireless communication service, the satellite network can be stored on the mobile network blacklist. In aspects, the mobile network blacklist can be stored on the SIM card. In this way, the present technology can be implemented by the mobile network operator through the SIM card without requiring additional changes to the wireless device by the manufacturer of the wireless device.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

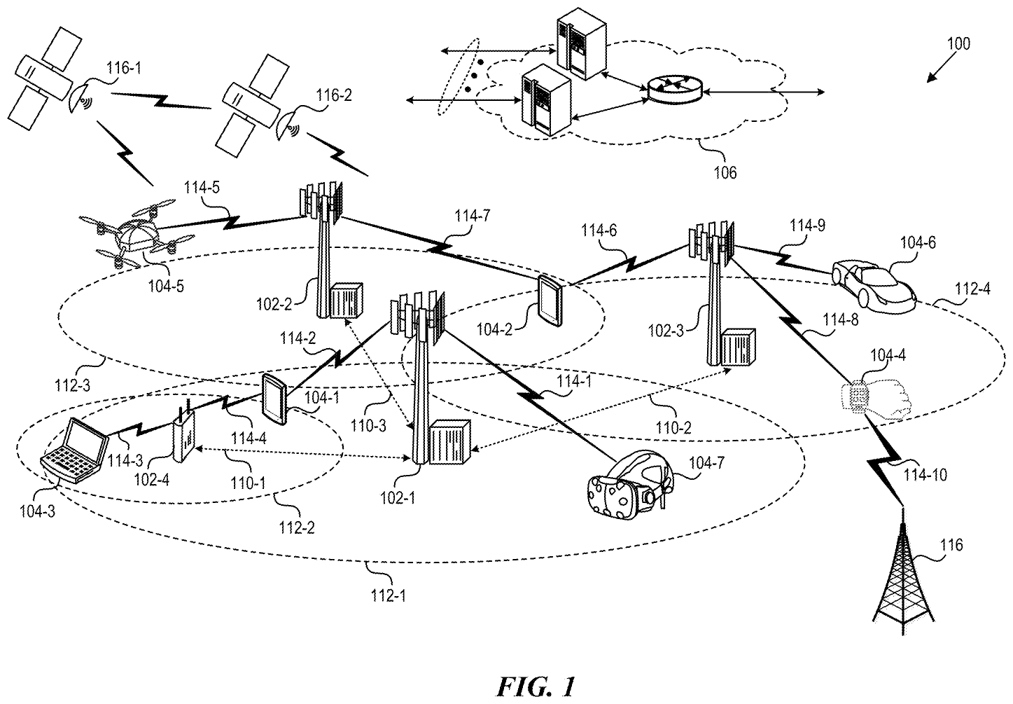

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 (Gigahertz) GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid Automatic Repeat Request (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a UE, a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-10 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, an NTN is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5G Core Network Functions

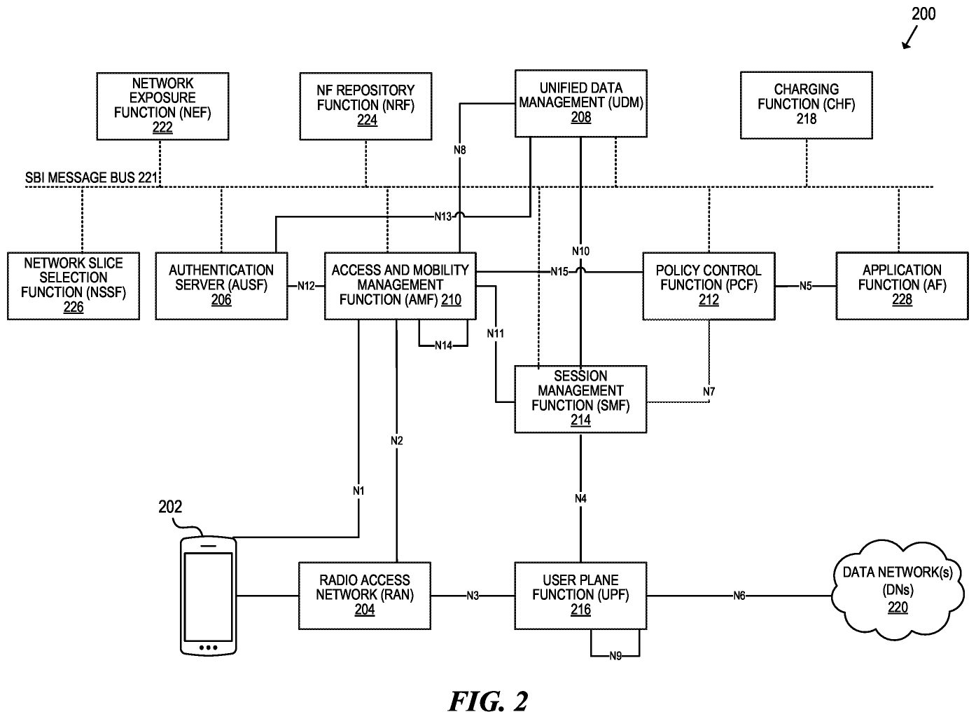

FIG. 2 is a block diagram that illustrates an architecture 200 including 5G core NFs that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service-Based Architecture (SBA) through a Service-Based Interface (SBI) 221 that uses Hypertext Transfer Protocol 2 (HTTP/2). The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given that a large number of wireless devices can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a data center, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Mobile Network Blacklist

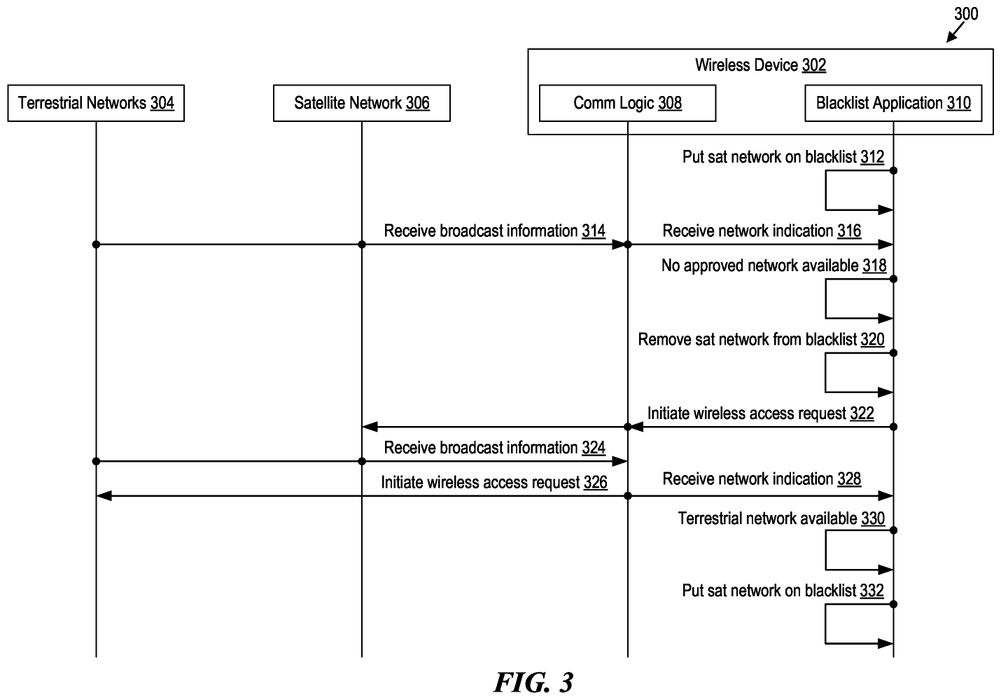

FIG. 3 illustrates a method 300 for managing a mobile network blacklist for satellite networks in accordance with aspects of the present technology. Although illustrated in a particular configuration, one or more operations of the method 300 may be omitted, repeated, or reorganized. Additionally, the method 300 may include other operations not illustrated in FIG. 3, for example, operations detailed in one or more other methods described herein.

As illustrated, a wireless device 302 (e.g., an example of the wireless device 104 of FIG. 1) communicates with one or more terrestrial networks 304 and at least one satellite network 306 (or NTN). The terrestrial networks 304 can be implemented through any number of base stations located at the surface of the Earth. The terrestrial networks 304 can include a home terrestrial network, one or more partnered terrestrial networks, and one or more non-partnered terrestrial networks. The home terrestrial network can have an MCC and an MNC that is the same as the MCC and the MNC indicated with an IMSI of the wireless device 302. The partnered terrestrial networks can have a partnership agreement with the home mobile network to provide roaming services to the wireless device 302 within a coverage area of the partnered terrestrial networks. In some cases, the partnered terrestrial networks can be indicated with an Operator PLMN (OPLMN) list of the wireless device 302. The non-partnered terrestrial networks may not have a partnership agreement in place with the home terrestrial network but may still provide some limited services to the wireless device 302, such as emergency services, within a coverage region of the non-partnered terrestrial networks.

The satellite network 306 can be implemented through at least one satellite orbiting the Earth. As illustrated, the satellite network includes a satellite network provided by a same mobile network provider as the home terrestrial network or having a partnership agreement with the home terrestrial network. Thus, the satellite network 306 can provide wireless communication services to the wireless device 302 within a coverage region of the satellite network 306. In aspects, non-partnered satellite networks can provide only limited services to the wireless device 302. As a result, non-partnered satellite networks can be treated similarly to non-partnered terrestrial networks in that the wireless device generally will not attempt to connect with non-partnered networks when requesting non-emergency services.

The wireless device 302 includes communication logic 308 capable of controlling the transmission of signaling to the terrestrial networks 304 and the satellite network 306 and the reception of signaling from the terrestrial networks 304 and the satellite network 306 using a wireless transceiver. The communication logic 308 can be implemented in hardware, software, or firmware. In aspects, the communication logic 308 can process the signals received at the wireless transceiver in accordance with a communication technology. For example, the communication logic 308 can compare broadcast information received from available networks to information related to approved networks to determine if an approved network is available to provide a wireless communication service to the wireless device 302. The communication logic 308 can forward an indication of the determination to a blacklist application 310 responsible for managing a mobile network blacklist (e.g., an FPLMN list). In other cases, the communication logic 308 can forward the broadcast signals to the blacklist application 310, and the blacklist application 310 can be responsible for determining if the available networks include an approved network.

The blacklist application 310 can manage a mobile network blacklist of the wireless device 302. The mobile network blacklist can include a dedicated storage location at which information related to blacklisted networks can be stored. In aspects, at least a portion of the mobile network blacklist can be implemented on a SIM card of the wireless device 302. When information related to a network is listed in the mobile network blacklist, the wireless device 302 can be prevented from attempting to connect to the network. In aspects, at least a portion of the blacklist application 310 can be installed (e.g., as hardware, software, firmware, or any combination) onto the SIM card of the wireless device 302. In this way, the blacklist application 310 can be implemented with limited alterations to the hardware, software, or firmware of the wireless device 302.

At 312, the information related to the satellite network 306 can be stored within a mobile network blacklist. In some embodiments, the information related to the satellite network 306 can include a PLMN code of the satellite network. In general, a PLMN code can include an MCC and an MNC of a network. In aspects, the blacklist application 310 can store the information related to the satellite network 306 within the mobile network blacklist when the satellite network 306 is not the only network capable of providing a wireless communication service (e.g., voice or video calling, text, data, emergency services, and so on). As a result, the wireless device 302 can be prevented from attempting to connect with the satellite network 306 when one or more approved networks of the terrestrial networks 304 are available to provide the wireless communication service. The availability of the terrestrial networks 304 and the satellite network 306 can be determined based on broadcast information broadcasted from these networks, as discussed at 314.

At 314, the wireless device 302 can receive broadcast information related to and broadcasted by the terrestrial networks 304 or broadcast information related to and broadcasted by the satellite network 306. For example, the terrestrial networks 304 and the satellite network 306 can transmit their associated PLMN codes within system information blocks broadcast from the network. The broadcast information related to the terrestrial networks 304 and the satellite network 306 can be broadcast repeatedly at predetermined intervals. The wireless device 302 can receive the broadcast information from the terrestrial networks 304 using the communication logic 308 when within a coverage region of the terrestrial networks 304. The broadcast information can similarly be received from the satellite network 306 using the communication logic 308 when within a coverage region of the satellite network 306. If the wireless device 302 is outside of the coverage region of the terrestrial networks 304 or the satellite network 306, the wireless device 302 may be unable to receive the broadcast information. The broadcast information can be stored in the wireless device 302 for a predetermined period of time (e.g., a time period that the broadcast information is indicated as valid) or until updated broadcast information is received. For example, the broadcast information can be stored within a device memory or within the SIM card.

The communication logic 308 can analyze the broadcast information to select a network to which the wireless device 302 is to connect. The broadcast information can be analyzed at least once every predetermined period of time to enable network selection/reselection. As a specific example, broadcast information can be analyzed at least once every six minutes to enable network selection/reselection. In other cases, the broadcast information can be provided directly to the blacklist application 310 from the communication logic 308.

The communication logic 308 can compare the broadcast information to one or more lists of approved networks to which the wireless device 302 is approved to connect. In aspects, the approved networks can include a home terrestrial network of the wireless device 302 and at least one partnered terrestrial network partnered with the home network to allow the wireless device 302 to roam on the partnered network. The information associated with one or more of the approved networks can be stored in a list of approved mobile networks. For example, PLMN codes of the partnered networks can be stored within an OPLMN list of the wireless device 302. Thus, the broadcast information can be compared to the PLMN code of the home network and the PLMN codes within the OPLMN list to determine if networks with which the broadcast information is associated matches one or more approved networks. If so, the wireless device 302 can determine that an approved network is available to the wireless device 302.

The communication logic 308 can compare the broadcast information to information related to unapproved networks stored in a mobile network blacklist (e.g., PLMN codes indicated within the FPLMN list). If the broadcast information is associated with the same network as an unapproved network indicated in the FPLMN list, the network can be determined not to be an approved network. In some embodiments, the satellite network 306 can be indicated on the mobile network blacklist, as discussed at 312, and the communication logic 308 can receive broadcast information from the satellite network 306. As a result, the communication logic 308 can determine that the satellite network 306 is not an approved network to which the wireless device 302 can connect.

In some embodiments, the communication logic 308 can determine that an approved network to which the wireless device 302 can connect is available, but the communication logic 308 can determine that the approved network is capable of providing only a limited service to the wireless device 302. In aspects, the limited services can include only a subset of the wireless services requested by the wireless device 302. For example, the communication logic 308 can determine that the approved network is only available to provide emergency services (e.g., 911 calling or emergency location services) but not non-emergency voice calling or message services. As another example, the approved network is only available to provide message services but not voice calling services. In yet another example, the approved network is available to provide message or voice calling services but not data services. In response to the determination that the available approved network is only available to provide limited services, the communication logic 308 can determine that no approved network is available to provide the wireless communication service.

In some cases, the wireless device 302 can be outside the coverage region of the terrestrial networks 304 or the satellite network 306. As a result, the wireless device 302 may not receive broadcast information, and the communication logic 308 can determine that no network is available to provide the wireless communication service to the wireless device 302.

At 316, the communication logic 308 can provide an indication of the approved network availability to the blacklist application 310. In some embodiments, the communication logic 308 can provide the indication to the blacklist application 310 in response to determining the availability of an approved network to connect to the wireless device 302. Alternatively or additionally, the broadcast information can be stored in the device memory, and the blacklist application 310 can request (e.g., a location information request) the broadcast information from the device memory. The blacklist application 310 can request the indication of the approved network availability at least once every predetermined period of time to enable for network selection/reselection. As a specific example, blacklist application 310 can request the indication at least once every six minutes.

In some embodiments, the indication of the approved network availability includes data that indicates to the blacklist application 310 that no approved network is available to provide the wireless communication service. For example, a first value can indicate that an approved network is available to provide the wireless communication service, and a second value can indicate that no approved network is available to provide the wireless communication service. Alternatively or additionally, the indication of the approved network availability is only provided to the blacklist application 310 when no approved network is available to provide the wireless communications service. In other embodiments, the indication of the approved network availability can include the broadcast information broadcasted by the available networks, which can be used by the blacklist application to determine the approved network availability, as described at 314.

At 318, the blacklist application 310 determines that no approved network is available to provide the wireless communication service. The determination can be based on the indication of approved network availability provided at 316. For example, when the blacklist application 310 receives data indicating that no approved network is available to provide the wireless communication service, the blacklist application 310 can determine that no approved network is available to provide the wireless communication service. In some embodiments where the broadcast information is provided to the blacklist application 310, the blacklist application 310 can determine that no approved network is available to provide the wireless communication service by comparing the broadcast information to information associated with approved networks.

At 320, the blacklist application 310 removes the information related to the satellite network 306 from the mobile network blacklist. For example, a PLMN code of the satellite network 306 stored within the FPLMN list can be removed. The mobile network blacklist can be maintained on the SIM or on any other storage of or coupled with the wireless device 302. By removing the information related to the satellite network 306 from the mobile network blacklist, the wireless device 302 can initiate a wireless access request to the satellite network 306.

At 322, the wireless device 302 can initiate a wireless access request to an approved network that is available to provide the wireless communication service. The blacklist application 310 can initiate the wireless access request by instructing the communication logic 308 to perform at least a portion of a network selection/reselection procedure. For example, broadcast information received from the terrestrial networks 304 and the satellite network 306 can be compared against an updated set of allowed networks, where the satellite network 306 is now indicated as an allowed network on account of being removed from the mobile network blacklist. Thus, if broadcast information is received from the satellite network 306, the communication logic 308 can determine that the satellite network 306 corresponds to an allowed network and is available to provide the wireless communication service. As a result, the wireless device 302 can initiate the wireless access request to the satellite network 306 to request the satellite network 306 to provide the wireless communication service to the wireless device 302.

In some cases, the blacklist application 310 can initiate the wireless access request by instructing the communication logic 308 to rescan for broadcast information broadcasted from the terrestrial networks 304 and the satellite network 306. When the wireless device 302 is in the coverage region of the satellite network 306, broadcast information related to the satellite network 306 can be received at the wireless device 302. The broadcast information can be compared to the updated set of allowed networks, which include the satellite network 306. As a result, the wireless device 302 can initiate a wireless access request to the satellite network 306, which results in the wireless device 302 connecting to the satellite network 306 such that the satellite network 306 provides the wireless communication service to the wireless device 302. The wireless device 302 can remain connected to the satellite network 306 until the wireless device 302 attempts to reselect a network and finds a more suitable network (e.g., an approved terrestrial network, a network that provides a greater amount or higher QoS, and so on).

At 324, the wireless device 302 can receive broadcast information related to and broadcasted by the terrestrial networks 304 and broadcast information related to and broadcasted by the satellite network 306. The broadcast information can be compared to approved network information to determine if one or more approved terrestrial networks are available to provide the wireless communication service to the wireless device.

At 326, the wireless device 302 can determine that an approved available terrestrial network is available to provide the wireless communication service and initiate a wireless access request to the approved available terrestrial network. In doing so, the wireless device 302 can disconnect from the satellite network 306. Specifically, a network selection/reselection procedure can be performed based on received broadcast information from the terrestrial networks 304 and the satellite network 306. During the network selection/reselection procedure, the broadcast information can be compared to approved network information, which can be ranked such that the wireless device 302 will attempt to connect to some networks before others. For example, the approved network information can be ranked such that the wireless device 302 first attempts to connect to the home terrestrial network, then attempts to connect to the partner terrestrial networks if the home terrestrial network is not available, and then attempts to connect to the satellite networks 306 if none of the partner terrestrial networks are available.

The communication logic 308 can compare the broadcast information to the approved network in the hierarchical order. For example, the broadcast information can be compared to information indicative of the home terrestrial network to determine if one or more of the networks associated with the broadcast information correspond to the home terrestrial network. If so, the communication logic 308 can determine that an approved terrestrial network is available to provide the wireless communication service. Otherwise, the communication logic 308 can compare the broadcast information to the partnered terrestrial networks and, if one or more of the networks associated with the broadcast information correspond to at least one of the partnered terrestrial networks, the communication logic 308 can determine that an approved terrestrial network is available to provide the wireless communication service. If no home or partnered terrestrial network is available to provide the wireless communication service, the broadcast information can be compared to information indicative of the allowed satellite networks. If one or more of the networks associated with the broadcast information correspond to at least one of the approved satellite networks, the communication logic 308 can determine that an approved satellite network is available to provide the wireless communication service.

As illustrated, the communication logic 308 determines that an approved terrestrial network is available to provide the wireless communication service. The approved terrestrial network can be the home network or a partnered network. As a result, the satellite network 306 is no longer the only approved network capable of providing the wireless communication service.

At 326, and in response to determining that an approved terrestrial network is available to provide the wireless communication service, as discussed at 324, the wireless device 302 can initiate a wireless access request at 332 to the approved terrestrial network of the terrestrial networks 304 to connect to the approved terrestrial network. Once connected to the approved terrestrial network, the approved terrestrial network can provide the wireless communication service to the wireless device 302. Moreover, connecting to the approved terrestrial network can cause the wireless device 302 to disconnect from the satellite network 306.

At 328, the communication logic 308 can provide an indication of the approved network availability to the blacklist application 310. The indication of the approved network availability can be provided to the blacklist application 310 in a similar way as discussed at 316. For example, the indication of the approved network availability can be provided at a predetermined frequency, in response to a request (e.g., a location information request) from the blacklist application 310, or at any other time. The indication of the approved network availability can include the broadcast information from the available networks or an indication of whether an approved terrestrial network is available to provide the wireless communication service to the wireless device 302. In some cases, the approved network availability information can include an indication of the network to which the wireless device 302 is currently connected. As illustrated, the communication logic 308 can provide information related to the approved terrestrial network to the blacklist application 310 given that the wireless device 302 can connect to the approved terrestrial network in response to the wireless access request at 326. In the illustrated example, the network availability information indicates that the approved terrestrial network is available to provide the wireless communication service.

Although the reception of the approved network information is indicated as being initiated at 328 during a same period in which the wireless access request to the approved terrestrial network is initiated at 330, in other embodiments the reception of the approved network information can be received before the wireless access request is initiated at 326 and after the broadcast information is received at 324 or after the wireless access request is initiated at 326.

At 330, the blacklist application 310 determines that an approved terrestrial network is available to provide the wireless communication service. The determination can be based on the indication of approved network availability provided at 328. For example, the indication of approved network availability can include an indication that an approved terrestrial network is or is not available to provide the wireless communication service. Alternatively or additionally, the indication of approved network availability can include information related to a currently connected network. The blacklist application 310 can then determine if an approved terrestrial network is available to provide the wireless communication service based on the currently connected network being a terrestrial or satellite network (e.g., because the satellite network can be connected to when no approved terrestrial network is available). In some embodiments, the indication of approved network availability is only provided to the blacklist application 310 when an approved terrestrial network is available to provide the wireless communication service. In implementations in which the broadcast information is provided to the blacklist application 310, the blacklist application 310 can determine that an approved terrestrial network is available to provide the wireless communication service by comparing the broadcast information to information associated with approved networks.

At 332, and in response to the determination that an approved terrestrial network is available to provide the wireless communication service, the blacklist application 310 stores the information related to the satellite network 306 within the mobile network blacklist. For example, the blacklist application 310 can store the PLMN code of the satellite network within the FPLMN list. As a result, the wireless device 302 can be prohibited from initiating an access request to the satellite network 306. The method 300 can then proceed again at 314.

### Computing System

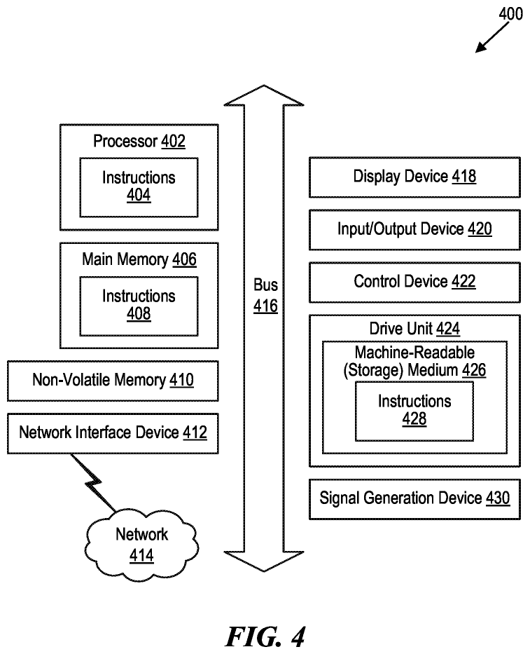

FIG. 4 is a block diagram that illustrates an example of a computing system 400 in which at least some operations described herein can be implemented. As shown, the computing system 400 can include one or more processors 402, main memory 406, non-volatile memory 410, a network interface device 412, a display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computing system 400 is intended to illustrate a hardware device on which components illustrated or described relative to the examples of the figures and any other components described in this specification can be implemented.

The computing system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 400. In some implementations, the computing system 400 can be an embedded computing system, a system-on-chip (SOC), a single-board computing (SBC) system, or a distributed system such as a mesh of computing systems, or it can include one or more cloud components in one or more networks. Where appropriate, one or more computing systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable (storage) medium 426) can be local, remote, or distributed. Although shown as a single medium, the machine-readable (storage) medium 426 can include multiple media (e.g., a centralized/distributed database and/or associated caches and servers) that store one or more sets of instructions 428. The machine-readable (storage) medium 426 can include any medium that is capable of storing, encoding, or carrying a set of instructions for execution by the computing system 400. The machine-readable (storage) medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system comprising:
at least one hardware processor; and
at least one non-transitory memory storing instructions that, when executed by the at least one hardware processor, cause the system to:
store a Public Land Mobile Network (PLMN) code of a satellite network within a Forbidden PLMN (FPLMN) list,
wherein the system is prevented from initiating a wireless access request to a mobile network indicated within the FPLMN list;
determine that none of one or more approved networks are available to provide a wireless communication service,
wherein the one or more approved networks include a home terrestrial network to which the system is subscribed or one or more roaming terrestrial networks partnered with the home terrestrial network to provide the wireless communication service;
in response to the determination that none of the one or more approved network are available to provide the wireless communication service, remove the PLMN of the satellite network from the FPLMN list; and
initiate a first wireless access request to the satellite network,
wherein the first wireless access request requests for the satellite network to provide the wireless communication service to the system.

2. The system of claim 1, wherein the instructions further cause the system to:
in response to initiation of the first wireless access request, connect to the satellite network such that the wireless communication service is provided through the satellite network;
after connecting to the satellite network, determine that an approved terrestrial network from the one or more approved networks is available to provide the wireless communication service;
in response to the determination that the approved terrestrial network is available to provide the wireless communication service, add the PLMN code of the satellite network to the FPLMN list; and
initiate a second wireless access request to the approved terrestrial network,
wherein the second wireless access request requests for the approved terrestrial network to provide the wireless communication service.

3. The system of claim 1, wherein the instructions further cause the system to:
receive one or more PLMN codes associated with one or more mobile networks;
determine that none of the one or more PLMN codes are associated with any of the one or more approved networks; and
in response to the determination that none of the one or more PLMN codes are associated with any of the one or more approved networks, determine that none of the one or more approved network are available to provide the wireless communication service.

4. The system of claim 1, wherein the instructions further cause the system to:
receive a first PLMN code of the satellite network;
in response to reception of the first PLMN code of the satellite network, determine that the first PLMN code is associated with the satellite network; and
in response to the determination that the first PLMN code is associated with the satellite network, determine that none of the one or more approved network are available to provide the wireless communication service.

5. The system of claim 1, wherein the instructions further cause the system to:
receive one or more PLMN codes associated with one or more mobile networks;
determine that none of the one or more PLMN codes are associated with the home terrestrial network;
in response to the determination that none of the one or more PLMN codes are associated with the home terrestrial network, determine that none of the one or more PLMN codes are associated with any of the one or more roaming terrestrial networks; and
in response to the determination that none of the one or more PLMN codes are associated with the home terrestrial network or any of the one or more roaming terrestrial networks, determine that none of the one or more approved networks are available to provide the wireless communication service.

6. The system of claim 1, wherein the instructions further cause the system to:
receive a first PLMN code of a first non-partner terrestrial network that is not partnered with the home terrestrial network;
in response to reception of the first PLMN code of the first non-partner terrestrial network, determine that the first PLMN code is not associated with any of the one or more approved networks; and
in response to the determination that the first PLMN code of the first non-partner terrestrial network is not associated with any of the one or more approved networks, determine that none of the one or more approved networks are available to provide the wireless communication service.

7. The system of claim 1, wherein the instructions further cause the system to:
receive an indication that none of the one or more approved networks are available to provide the wireless communication service; and
in response to the reception of the indication that none of the one or more approved network are available to provide the wireless communication service, determine that none of the one or more approved network are available to provide the wireless communication service.

8. The system of claim 1, wherein the instructions further cause the system to:
receive one or more PLMN codes associated with one or more mobile networks;
determine that at least one of the one or more PLMN codes is associated with a first network of the one or more approved networks;
determine that the first network is available to provide a limited wireless communication service that has less capability than the wireless communication service; and
in response to the determination that the first network is available to provide the limited wireless communication service, determine that none of the one or more approved networks are available to provide the wireless communication service.

9. At least one non-transitory, computer-readable storage medium storing instructions, which, when executed by at least one data processor of a system, cause the system to:
store information indicative of a satellite network within a mobile network blacklist,
wherein the system is prevented from initiating a wireless access request to a mobile network indicated within the mobile network blacklist;
determine that no approved network is available to provide a wireless communication service; and
in response to the determination that no approved network is available to provide the wireless communication service, remove the information indicative of the satellite network from the mobile network blacklist,
wherein the removal of the information indicative of the satellite network from the mobile network blacklist enables the system to initiate a first wireless access request to the satellite network.

10. The at least one non-transitory, computer-readable storage medium of claim 9, wherein the instructions further cause the system to:
in response to removal of the information indicative of the satellite network from the mobile network blacklist, transmit a request to receive respective broadcast information for one or more respective mobile networks,
wherein the one or more respective mobile networks include the satellite network, and
wherein the system will initiate the first wireless access request to the satellite network in response to receiving the respective broadcast information from the satellite network.

11. The at least one non-transitory, computer-readable storage medium of claim 9, wherein the instructions further cause the system to:
receive respective broadcast information indicative of one or more respective mobile networks;
determine that none of the respective broadcast information indicative of the one or more respective mobile networks are associated with an approved network; and
in response to the determination that none of the respective broadcast information indicative of the one or more respective mobile networks are associated with the approved network, determine that no approved network is available to provide the wireless communication service.

12. The at least one non-transitory, computer-readable storage medium of claim 9, wherein the instructions further cause the system to:
receive broadcast information indicative of the satellite network;
in response to reception of the broadcast information indicative of the satellite network, determine that the broadcast information indicative of the satellite network is associated with the satellite network; and
in response to the determination that the broadcast information indicative of the satellite network is associated with the satellite network, determine that no approved network is available to provide the wireless communication service.

13. The at least one non-transitory, computer-readable storage medium of claim 9, wherein the instructions further cause the system to:
receive respective broadcast information indicative of one or more respective mobile networks;
determine that none of the respective broadcast information indicative of the one or more respective mobile networks are associated with a home terrestrial network having a first Mobile Country Code and a first Mobile Network Code matching a second Mobile Country Code and a second Mobile Network Code within an International Mobile Subscriber Identity Number of the system;
in response to the determination that none of the respective broadcast information indicative of the one or more respective mobile networks are associated with the home terrestrial network, determine that none the respective broadcast information indicative of the one or more respective mobile networks are associated with a roaming terrestrial network partnered with the home terrestrial network; and
in response to the determination that none of the respective broadcast information indicative of the one or more respective mobile networks are associated with the home terrestrial network or the roaming terrestrial network, determine that no approved network is available to provide the wireless communication service.

14. The at least one non-transitory, computer-readable storage medium of claim 9, wherein the instructions further cause the system to:
receive an indication that no approved network is available to provide the wireless communication service; and
in response to the reception of the indication that no approved network is available to provide the wireless communication service, determine that no approved network is available to provide the wireless communication service.

15. The at least one non-transitory, computer-readable storage medium of claim 9, wherein the instructions further cause the system to:
receive respective broadcast information indicative of one or more respective mobile networks;
determine that at least one of the respective broadcast information indicative of the one or more respective mobile networks is associated with an approved network to which the system is approved to connect;
determine that the approved network is available to provide a limited wireless communication service that has less capability than the wireless communication service; and
in response to the determination that the approved network is available to provide the limited wireless communication service, determine that no approved network is available to provide the wireless communication service.

16. The at least one non-transitory, computer-readable storage medium of claim 9, wherein the at least one non-transitory computer-readable storage medium is located on a Subscriber Identity Module (SIM) card.

17. At least one non-transitory, computer-readable storage medium storing instructions, which, when executed by at least one data processor of a system, cause the system to:
connect to a satellite network such that a wireless communication service is provided through the satellite network;
after connecting to the satellite network, determine that a first approved terrestrial network is available to provide the wireless communication service; and
in response to the determination that the first terrestrial network is available to provide the wireless communication service, add information indicative of the satellite network to a mobile network blacklist,
wherein the system is prevented from initiating a wireless access request to a mobile network indicated within the mobile network blacklist.

18. The at least one non-transitory, computer-readable storage medium of claim 17, wherein the instructions further cause the system to, in response to the determination that the first approved terrestrial network is available to provide the wireless communication service, disconnect from the satellite network.

19. The at least one non-transitory, computer-readable storage medium of claim 17, wherein the instructions further cause the system to:
receive an indication that the first approved terrestrial network is available to provide the wireless communication service; and
in response to the reception of the indication that the first approved terrestrial network is available to provide the wireless communication service, determine that the first approved terrestrial network is available to provide the wireless communication service.

20. The at least one non-transitory, computer-readable storage medium of claim 17, wherein the at least one non-transitory computer-readable storage medium is located on a Subscriber Identity Module (SIM) card.
